(19) United States
(12) Patent Application Publication
(10) Pub. No.: US 2010/0152032 A1
(43) Pub. Date: Jun. 17, 2010

(54) Aircraft Air Treatment Catalysts, Systems and Methods

(75) Inventor: Michael P. Galligan, Cranford, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/335,903

(22) Filed: Dec. 16, 2008

(51) Int. Cl. B01J 23/34; B01J 27/25; B01J 21/08

(52) U.S. Cl. 502/201; 502/324; 502/241

(57) ABSTRACT

Aircraft catalysts, systems, and methods are disclosed. In one or more embodiments, the catalysts comprise a substrate, at least a first washcoat layer on the substrate comprising a refractory metal oxide support having a catalytic metal component dispersed on the refractory metal oxide support, and an overcoat washcoat layer on the first layer comprising a manganese component. Catalysts prepared in accordance with embodiments of the invention exhibit improved life when used in aircraft.

### BACKGROUND

Embodiments of the present invention relate to catalyst compositions and aircraft air treatment systems and methods. More specifically, embodiments of the present invention relate to an aircraft air treatment system including an ozone-destroying catalyst exhibiting excellent durability.

Is has been long recognized that ozone is present in the atmosphere in toxic concentrations at altitudes at which aircraft fly. Aircraft flying at altitudes of about 9 to 46 kilometers scoop in cabin air from the outside atmosphere which, because it is very much compressed, is raised in temperature to several hundred degrees Centigrade. Such air is treated with an air treatment system including an ozone converting catalyst to reduce the ozone concentration of it to below 1 part per million (“ppm”) to render it fit for use as cabin air.

Aircraft air treatment systems provide a stream of cooled, conditioned air to the aircraft cabin. An aircraft air treatment system receives compressed air such as bleed air from a compressor stage of an aircraft gas turbine engine, expands the compressed air in a cooling turbine, and removes moisture from the compressed air via a water extractor.

Ozone-destroying catalytic converters should exhibit high efficiency of ozone conversion at bleed air operating temperatures and acceptable poison resistance from humidity, sulfur compounds, oil, dust, and other contaminants, which may be present in the compressed air. In addition, it is desirable for ozone-destroying catalytic converters to be light and have high structural integrity of catalyst support under extreme heat and/or vibration shock, which may arise during normal flight conditions. It is also desirable for ozone-destroying catalytic converters to exhibit high mass transport efficiency with low pressure drop.

Manufacture of ozone-destroying catalytic converters typically involves washcoating a ceramic or metal core with an aqueous slurry. Typically, aircraft ozone-destroying catalytic converters comprise the core having refractory metal-containing undercoat layer and an overcoat layer containing a catalyst. An example of ceramic core is described in U.S. Pat. No. 4,206,083, and an example of a metal core made from aluminum is described in U.S. Pat. No. 4,405,507, the entire content of each of these patents incorporated herein by reference. Aluminum cores are widely used due to their low cost and light weight. Typically, a plurality of washcoated cores, for example, about six cores, are used in an ozone-destroying catalytic converter system for an aircraft.

Certain aircraft manufacturers require the ozone-destroying catalytic converters to exhibit ozone destruction efficiency equal to or greater than 84.5% and greater after 3,000 flight hours. As noted above, chemical contaminants tend to inhibit the performance of ozone-destroying catalytic converters over time. It would be desirable to provide an ozone-destroying catalytic converter that exhibits ozone destruction efficiency equal to or greater than 84.5% and greater after 3,000 flight hours.

### SUMMARY

According to one aspect of the present invention, an ozone-destroying catalytic converter comprises a core or substrate;

The ozone-destroying catalyst exhibits ozone destruction efficiency equal to or greater than about 84.5% and greater after about 3,000 flight hours.

Another aspect of the invention pertains to a method of making an ozone-destroying catalytic converter. The overcoat layer provides a corrosion barrier that prevents contaminants from destroying the ozone-destruction efficiency of the catalytic converter in use.

### BRIEF DESCRIPTION OF THE DRAWINGS

FIG. 1 shows the results of measurements collected from a field aged catalyst;

FIG. 2 shows the results of measurements collected from the field aged catalyst of FIG. 1 for various axial and radial positions;

FIG. 3 shows electron microprobe analysis of sample cores from the field aged catalyst of FIG. 1;

FIG. 4 shows performance results for catalyst tested at a range of space velocities and temperatures for samples tested in a model gas reactor; and

FIG. 5 shows testing results and an improvement in converter efficiency for fresh samples and samples chemically contaminated with engine oil.

Before describing several exemplary embodiments of the invention, it is to be understood that the invention is not limited to the details of construction or process steps set forth in the following description. The invention is capable of other embodiments and of being practiced or being carried out in various ways.

### DETAILED DESCRIPTION

Embodiments of the invention pertain to an ozone destroying catalytic converter. Another aspect of the invention pertains to a method of manufacturing an ozone destroying catalyst or converter. The ozone-destroying catalyst comprises an undercoat layer on a substrate or core, a first layer on the undercoat layer and an overcoat layer on the first layer. In one or more embodiments, the layers are in the form of a washcoat.

Many suitable substrates (sometimes referred to in the art as “supports” or “carriers”) may be utilized to support catalyst compositions thereon. For example, it is known to utilize substrate bodies, often referred to as “honeycombs”, comprising a monolithic body having a plurality of fine, parallel gas flow channels extending therethrough. Such substrates may be extruded from ceramic-like compositions such as cordierite or other similar highly refractory materials. Although such cordierite or other ceramic-like substrates are useful in many applications, they are heavier than some metal substrates and, because the walls thereof are usually thicker than the walls of metal substrates, cause a higher pressure drop in gases forced through them than do similar catalysts in which the substrate is formed of a metal. Further, cordierite and other such substrate bodies are more susceptible to mechanical and thermal shock damage than are metal substrates.

A suitable catalytic material is applied to the substrate by coating the gas flow passages of the substrate with the catalytic material. Usually, such catalytic material comprises a fine particulate refractory metal oxide, such as a high surface area alumina, on which is dispersed one or more catalytic metal components.

Ozone abatement catalysts, especially those containing a palladium catalytic component, are effective at temperatures as low as about 100° F. (37.7° C.), although the rate of ozone abatement is increased if the air or other gas stream being treated is heated to a higher temperature. Nonetheless, in some applications it is highly desirable to have the catalyst composition be effective over a broad range of inlet gas temperatures, on the order of about 100° to 300° F. (21.1° to 148.9° C.). For effective low temperature operation, it is desirable that a high density of the noble catalytic metal, such as palladium, be attained in highly dispersed form on the refractory metal oxide support. In the present invention, any soluble palladium salt may be used as long as the palladium salt is soluble in the washcoat solution and can be dispersed onto a refractory oxide support. Examples of soluble palladium salts usable herein include ammine complex salts, nitrates, and chlorides of palladium. Among them, suitable amine complex salts of palladium include chlorides, bromides, iodides, nitrites, nitrates, and sulfates of palladium ammine complex salts. Preferred ammine complex salts include diamine complex salts and tetraamine complex salts. Accordingly, specific examples thereof include dichlorotetraaminepalladium (Pd(NH₃)₄Cl₂), dibromotetraaminepalladium (Pd(NH₃)₄Br₂), tetraaminepalladium diiodide (Pd(NH₃)₄I₂), tetraaminepalladium dinitrite (Pd(NH₃)₄(ONO)₂), tetraaminepalladium dinitrate (Pd(NH₃)₄ (NO₃)₂), tetraaminepalladium disulfite (Pd(NH₃)₄(SO₃)₂), tetraaminepalladium disulfate (Pd(NH₃)₄(SO₄)₂), dinitrotetraaminepalladium (Pd(NH₃)₄(NO₂)₂), dichlorodiaminepalladium (Pd(NH₃)₂Cl₂), dibromodiaminepalladium (Pd(NH₃)₂Br₂), diaminepalladium diiodide (Pd(NH₃)₂I₂), diaminepalladium dinitrite (Pd(NH₃)₂(ONO)₂), diaminepalladium dinitrate (Pd(NH₃)₂(NO₃)₂) diaminepalladium disulfite(Pd(NH₃)₂(SO₃)₂), diaminepalladium disulfate (Pd(NH₃)₂(SO₄)₂), and dinitrodiaminepalladium (Pd(NH₃)₂(NO₂)₂). These salts may be synthesized, or alternatively, commercially available products may be used.

As described in U.S. Pat. No. 5,620,672, the entire content of which is incorporated herein by reference, the desired high density of palladium catalytic component is enhanced if the soluble palladium salt used to impregnate the refractory metal oxide particles is a solution of a palladium amine salt, such as palladium tetraamine hydroxide or palladium tetraamine acetate, or palladium nitrate. The use of such salts, especially in combination with a high porosity refractory metal oxide support as described below is found to give higher densities of palladium with improved dispersion on the refractory metal oxide than that attainable under similar conditions with other palladium salts, such as palladium acetate or palladium chloride.

### The Substrate

As indicated above, metal substrates have certain advantages over cordierite or other ceramic-like substrates, including reduced pressure drop and, for certain metals, lower weight per unit of volume. Metal substrates are conventionally made by spiral-winding a flat and corrugated metal strip into a coil with the corrugations running parallel to the longitudinal axis of the coil to provide a plurality of fine, parallel gas flow passages extending through the metal substrate. The coil is stabilized to prevent “telescoping” of the spiral-wound metal strips by the utilization of pins or other mechanical fasteners driven through the coil or by brazing or spot or resistance welding the wound metal strip layers to each other. Such brazing or welding may take place either at one or both end faces, throughout the body, or at selected portions of the body, as is well-known in the art.

For ozone abatement catalysts intended for use on aircraft in order to abate ozone in air destined for use as cabin atmosphere, it is particularly important that the catalyst be of as low weight as possible. It has been found that a highly satisfactory catalyst of light weight can be made in accordance with the teachings of the present invention by utilizing a metal substrate in which the metal is aluminum or an aluminum alloy such as an aluminum-magnesium alloy. Alternatively, the metal substrate may be made of titanium or a titanium alloy. However, aluminum is lighter than titanium, less expensive and easier to weld or braze in order to form a satisfactory metal substrate. Accordingly, metal substrates made of aluminum or aluminum alloys are, to that degree, preferred. In particular, an aluminum-magnesium alloy provides greater hardness, strength and corrosion resistance than aluminum, but cannot readily be brazed due to the magnesium content. Accordingly, aluminum-magnesium alloy metal substrates would have to rely on pins or other mechanical fasteners to provide a rigid metal substrate structure.

Generally, any suitable substrate material may be employed, including cordierite or other ceramic-like materials, as well as suitable metals other than aluminum, titanium and their alloys, such as Inconel metals, e.g., Inconel 625, and suitable stainless steels such as 304, 316 and 404 stainless steels. Other suitable metal substrates include, but are not limited to a FeCr alloy or HASTELLOY®. HASTELLOY® is a trademark for an alloy whose major components are nickel-chromium and molybdenum and contain minor components comprising cobalt, iron and tungsten.

Generally, the metal substrates have substantially thinner walls than cordierite or other ceramic-like substrates and yet provide adequate mechanical strength and better resistance to thermal shock than do cordierite or similar substrates, and to that extent are preferred. The thinner walls of metal substrates as compared to cordierite substrates assist in reducing the pressure drop sustained by a gas forced through the substrate.

The metal strip or foil used to manufacture the metal substrate of the catalyst can have a thickness of from about 1 to 3 mils and, in one embodiment, may be configured to have about 400 cells (gas flow channels) per square inch (62 cells per square centimeter) of end face area. Metal substrates useful in the present invention may be configured to have anywhere from 100 to 600 cells per square inch (15.5 to 93.0 cells per square centimeter) of end face area, specifically from 300 to 500 cells per square inch (46.5 to 77.5 cells per square centimeter).

### Optional Undercoat Layer

As described in U.S. Pat. No. 5,620,672, a difficulty which results from the utilization of metal substrates is that of obtaining adequate adherence of the coating of catalytic material to the substrate. This problem may be overcome by the provision of a highly adherent bonding undercoat over which a first layer containing one or more catalytic metal components is applied. An example of a suitable undercoat is made from a low chloride sol which contains less than 50 ppm by weight of chlorides. Other suitable sols such as low chloride alumina, titania and zirconia sols may also be employed in the compositions of the present invention.

An undercoat washcoat may be prepared by combining the sol with a fine particulate refractory metal oxide. In order to distinguish the refractory metal oxide used in the undercoat from that which may be used in the first layer described below, the refractory metal oxide used in the undercoat is sometimes herein referred to as the “undercoat refractory metal oxide”. The undercoat refractory metal oxide may comprise, for example, particles of a particle size such that 90% by volume of the particles are 2 microns or less in diameter. The refractory metal oxide particles, for example, activated alumina particles coated with silica, are mixed with the silica sol in an aqueous medium and, optionally, a chloride scavenger such as particulate silver oxide may be added thereto. The slurry may contain from about 5 to 50 percent by weight refractory metal oxide particles and from about 50 to 95 percent by weight (dry solids basis) of the sol and the total solids content (dry basis) of the slurry utilized may be from about 10 to 30 percent by weight of the total weight of the slurry. It will be appreciated that any suitable refractory metal oxide particles may be employed, such as activated alumina particles (comprising predominantly gamma-alumina although other phases such as delta and theta are usually present), silica particles, zirconia particles or titania particles, or mixtures or composites of one or more of the foregoing.

The metal substrate, for example, an aluminum or aluminum alloy substrate, is dipped into the slurry so that the fine gas flow passages of the honeycomb are completely coated by the slurry. Alternatively, slurry may be drawn through the fine gas flow panels by suction. Excess slurry may be blown out of the gas flow channels with compressed air. The coated substrate may be dried in air and then calcined in air at a temperature of about 300° C. to 600° C. for a period of from about one-quarter to two hours, in order to fix the undercoat to the substrate. Optionally, the metal strips from which the metal substrate is prepared may be chemically treated or otherwise have their surfaces roughened to promote better adherence between the undercoat and the metal.

### The First Layer

The first layer over the optional undercoat comprises catalytic metal components on a refractory oxide support, as described in U.S. Pat. No. 5,620,672, which is incorporated herein by reference in its entirety. The catalytic metal component or components are dispersed on the first layer, which may comprise refractory metal oxide particles which serve as a support on which the one or more catalytic metal components are dispersed. The first layer is deposited on either the substrate, or the undercoat (if present), either directly or with an intermediate layer between the undercoat first layer. The refractory metal oxide support used in the first layer may be the same as or different from the refractory metal oxide used in the undercoat. In order to distinguish it from the refractory metal oxide used in the undercoat, the refractory metal oxide support used in the first layer is sometimes herein referred to as the “first layer refractory metal oxide support” or “first layer refractory metal oxide support”. Any suitable refractory metal oxide, such as any of those identified above as suitable for the undercoat refractory metal oxide, may be used as the first layer refractory metal oxide to provide a support for the catalytic metal component or components. Generally, particles of high surface area, e.g., from about 100 to 500 square meters per gram (“m²/g”) surface area, specifically from about 150 to 450 m²/g, more specifically from about 200 to 400 m²/g, are desired so as to better disperse the catalytic metal component or components thereon. The first layer refractory metal oxide also desirably is mesoporous and has a high porosity of pores up to 1456 Angstroms radius, e.g., from about 0.75 to 1.5 cubic centimeters per gram (“cc/g”), specifically from about 0.9 to 1.2 cc/g, and a pore size range of at least about 50% of the porosity being provided by pores of 50 to 1000 Angstroms in radius. For example, the first layer refractory metal oxide may be a silica alumina comprising from about 1 to 10 percent by weight silica and from about 90 to 99 percent by weight alumina.

The first layer refractory metal oxide may be impregnated with one or more suitable catalytic metal salts, such as a manganese salt, specifically a combination of two manganese salts. For example, a soluble non-chloride manganese salt, e.g., manganese nitrate, may be added to cristobalite to further impregnate the first layer refractory metal oxide powder with a precursor of manganese or manganese oxide. The resulting impregnated refractory metal oxide powder may then be slurried with distilled water and other catalytic metal components may be added to the slurry. For example, a soluble platinum group metal salt, e.g., a palladium salt, may be added to further impregnate the first layer refractory metal oxide powder with a precursor of a platinum group metal component. The contents of the first layer slurry are thoroughly blended and the undercoated substrate is then coated with the first layer slurry of metal- and/or metal compound-impregnated first layer refractory metal oxide in a manner similar to that in which the undercoat was applied. The coated substrate is then dried and calcined.

The manganese catalytic metal components have been found to be particularly effective for the abatement of ozone in airstreams, even at relatively low operating temperatures. Alternatively, a slurry of the first layer refractory metal oxide may be coated over the undercoat, dried and calcined and the thus substrate immersed in one or more solutions of suitable catalytic metal salts, dried and calcined.

Obviously, different catalytic metal components may be utilized depending on the intended use of the catalyst. In some embodiments, catalytic metal components which are useful for the abatement of ozone may be supplemented with other catalytic metal components. The manganese oxide components which are preferred for an ozone abatement catalyst may also be useful for other pollutants. For example, a manganese catalytic component is known to react with hydrogen sulfide and may release the sulfur as sulfur dioxide if elevated temperatures are attained. In addition, the oxidation of carbon monoxide and hydrocarbons can take place with a palladium and manganese catalytic component-containing catalyst as the catalyst heats up somewhat during operation. Obviously, heating means may be supplied to heat the catalyst itself or the gas stream being introduced to the catalyst. Carbon monoxide and hydrocarbons are generated by tobacco smoke so the preferred ozone abatement catalyst of the invention may be employed to treat not only makeup air introduced from outside the aircraft (or other vehicle) but to treat recycled cabin air which might contain the products of tobacco combustion. Generally, the catalysts of the invention will find a variety of uses. For example, those embodiments of the invention useful for ozone abatement may be used to treat not only the cabin atmosphere of aircraft, trains, buses and other vehicles, but to abate ozone in equipment, such as xerographic copy machines, which generate ozone. The catalyst of the present invention may also be employed for air handling systems for residences, office and factory buildings, public buildings, hospitals and the like. Systems can conveniently include means to heat the air being introduced into the catalyst and/or to heat the catalyst itself in order to enhance conversion efficiency. In air handling systems, the substrate on which the catalyst is coated need not be a honeycomb-type carrier or other substrate specifically configured to support a catalyst, but the catalytic material could be applied to any portion of the air handling system in which the air sustains turbulent flow. Thus, a catalytic material may be applied to the blades of an air handling fan or compressor, to a grill, louvers or other air-directing structure disposed immediately downstream (as sensed in the direction of air movement) from the blades of the fan or compressor, or on other structures over which the air of the air handling system is forced in turbulent flow. For applying the catalyst to such structures, for example fan blades, the fan blades would be sandblasted or otherwise treated to remove any paint or finish and to roughen the surface to accept the catalyst composition to be applied thereto. After such treatment, the fan blades or other structure (louvers, grills, etc.) may be coated, for example, with an undercoat and first layer to provide a catalytic material coating as described elsewhere herein.

For an ozone abatement catalyst, the catalyst loading is specifically in the range of about 150 to about 450 grams of palladium per cubic foot of catalyst volume. (The catalyst volume is the volume of the finished catalyst and therefore includes the void spaces provided by the fine gas flow passages of the metal substrate. All references herein and in the claims to a grams per cubic foot (“g/ft³”) or grams per cubic inch (“g/in³”) loading or quantity refer to the weight per unit volume of the catalyst composition, i.e., the catalytic material coated onto the substrate.)

The catalytic component provides a catalyst which can decompose 90 to 95 percent of the ozone content of a treated gas (air) stream by employing, for example, a five-segment or seven-segment catalyst and an inlet temperature of the gas (e.g., air) of 70° to 100° F. (21.1° to 37.7° C.). The individual segments are from 0.5 to 1.5 inches in length (the length of the gas flow passages) and are desirably spaced apart about 0.063 to 0.25 inches (0.160 to 0.635 centimeters) from each other in order to provide turbulence-inducing empty spaces between adjacent segments to break up laminar flow of the gas being treated. The use of multiple, spaced-apart segments of catalyst is a known expedient in the art. The empty spaces between adjacent catalyst segments also promote mixing of the gas stream being treated thereby increasing the effectiveness of the catalytic action, especially at the relatively low temperatures at which ozone abatement is often carried out.

### The Protective Coat or Overcoat Layer

As noted above, certain aircraft manufacturers require the ozone-destroying catalytic converters to exhibit ozone destruction efficiency equal to or greater than 84.5% and greater after 3,000 flight hours. Chemical contaminants tend to inhibit the performance of ozone-destroying catalytic converters over time, causing ozone-destroying catalysts to fall short of this lifetime requirement. It has been determined that a protective coat or overcoat layer on the first layer comprising a manganese component provides sufficient protection of the catalyst in the first layer from chemical contaminants that inhibit the efficiency of ozone-destroying chemicals and to enable catalytic converters to exhibit ozone destruction efficiency equal to or greater than 84.5% and greater after 3,000 flight hours.

After formation of the first layer, an overcoat layer can be applied to the catalytic converter by making a slurry or washcoat of a manganese component, for example, a mixture of a high surface area manganese dioxide available from Chemetals, Inc., Baltimore, Md., manganese nitrate, both in an amount to provide a loading on the substrate of about 0.0112 g/in³ and a high surface area mesoporous gamma alumina, for example GA-200 mixed in the slurry to provide a loading on the substrate of about 0.1 to 2 g/in³, more specifically about 0.1 to 0.5 g/in³, and it specific embodiments about 0.2235 g/in³. Suitable manganese components include, but are not limited to manganese dioxide, non-stoichiometric manganese dioxide, cryptomelane, manjiroite and coronadite, Mn(NO₃)₂ and Mn₂O₃. The pH of the slurry can be adjusted as necessary to the range of 4.0 to 6.0, and the desired particle size of the particles in the slurry are in the range of 90% of the particles being less than 7 to 15 microns. The slurry can be applied as a washcoat on the first layer in an amount of about 0.25 g/in³ to provide an overcoat layer that protects the catalytic component in the first layer from degradation in use.

The following non-limiting examples demonstrate the testing of samples prepared in accordance with the above description and the benefits obtained from providing an overcoat layer or protective coating over the first layer containing a catalytic component for ozone destruction.

### Preparation and Testing of Samples

### Comparative Example 1

Samples were prepared as follows:

Catalysts made in accordance with U.S. Pat. No. 5,260,672, namely Examples 1-4, the entire content of which patent is incorporated herein by reference. Catalysts such as those described in U.S. Pat. No. 5,260,672 are available commercially from BASF Catalysts LLC, sold under the brand name BASF Catalysts's Deoxo®. These catalysts generally comprise a first layer or undercoat and a second layer or overcoat prepared as follows. Samples with two layers are comparative examples.

### Preparation of the Undercoat

1. A jet-milled silica-alumina support containing 5.5 weight percent silica dispersed on gamma-alumina particles, based on the combined weight of the silica and gamma-alumina is slurried in distilled water. This material was measured as having a surface area of 271 m²/g, an average pore radius of 74 Angstroms, and a total porosity of 1.00 cc/g. This material was ball milled to a particle size distribution of more than 90 percent by volume of the particles having a particle size of 2 microns diameter or less. The material is milled to a solids content in excess of 30% with approximately 0.5% by weight of acetic acid added on a solids basis.

2. A “chloride-free” silica sol containing less than 10 parts per million by weight (“ppm”) chloride has a particle size of about 200 Angstroms and a 27 to 28% true solids basis.

3. The materials of steps 1 and 2 are blended together in a ratio of three parts by weight of the silica sol (dry solids basis) to one part by weight of the silica-alumina support in distilled water to approximately an 18% solids concentration measured at 150° to 200° F. Distilled water is added as needed to provide the desired solids content. The viscosity of the resultant undercoat slurry is approximately 80 to 100 cps and the pH is between 8 to 9.

4. A series of metal substrates were made of aluminum and aluminum-magnesium alloys 3003, 5056 and 3104 (alloy numbering system of the American Aluminum Association). Flat and corrugated metal strips of these metals having a thickness of about 1 to 2 mils were spiral-wound to fabricate cylindrical metal substrates in which the flat and the corrugated strip alternated to provide about 400 cells per square inch (62.0 cells per square cm) of end face area. The metal substrates were about 0.85 inches (2.15 cm) long and 8.2 inches (20.83 cm) in diameter. The substrates were dipped into the above undercoat slurry and the cells (gas flow passages) were cleared with an air knife to the desired wet weight target.

5. The substrates were then dried with forced air at about 100.degree. C. and then calcined at 450° C. for 1 hour in air. Following calcination, an air gun was used to remove residual particles on the surface of the substrate. These undercoated substrates have a target loading of about 0.25 g/in³ of an undercoat layer, with a 0.2 to 0.3 g/in³ expected range, the undercoat layer comprising a 3:1 weight ratio of silica sol (dry solids basis) to silica-alumina refractory metal oxide.

### Preparation of the First Layer

This preparation uses the following materials: palladium tetraamine acetate solution, a silica-alumina refractory metal oxide, and manganous nitrate solution. All solutions are prepared with distilled water.

6. A jet-milled silica-alumina powder, the same silica-alumina used to prepare the undercoat, serves as the first layer refractory metal oxide to provide a support for the metal catalytic components. By the incipient wetness technique, the support is impregnated with a solution of palladium acetate, Pd(NH₃)₄(CH₃COOH)₂, in distilled water. By “incipient wetness technique” is meant that the amount of palladium tetraamine acetate solution applied to the silica-alumina powder is limited to avoid the formation of a distinct liquid phase, so that although the powder is thoroughly wetted by the solution, a slurry is not formed. The palladium tetraamine acetate solution contains about 12.3 weight percent palladium salt. The palladium salt solution is applied to the silica-alumina powder using a dispensing buret/drop column and is not diluted during the impregnation. After impregnation of the silica-alumina powder with the palladium salt solution, the powder is dried and calcined in a clean furnace at 450° C. for one hour in air. The Pd metal loading on the silica-alumina support for this catalyst is targeted at 250 g Pd/ft³, the silica-alumina loading is targeted at 1.2 g/in³ and the MnO loading is targeted at 0.07 g/in³. The target first layer loading is thus about 1.41 g/in³, including the Pd. The Pd metal concentration on the silica-alumina support, i.e., on the first layer refractory metal oxide, was 12.06 weight percent palladium metal.

7. The impregnated silica-alumina powder obtained in step 6 was then slurried in distilled water using a shear mixer and ball mill with a manganous nitrate solution and containing about 21.65% MnO equivalent in distilled water. The resulting first layer slurry is then blended to approximately 32 to 34% solids concentration at 150° to 200° F. Viscosity can range from 200 to 279 cps and the pH range is 4.8 to 5.3 at room temperature.

8. The substrates coated with the optional undercoat layer as described above are coated with the first layer slurry to the desired wet weight target by being dipped into the first layer slurry after which the cells (gas flow passages) are cleared with an air knife. The coated substrate is then dried and calcined at 450° C. for one hour in air. The heating decomposes the palladium salt to Pd or PdO and the manganese salt to an oxide of manganese.

The finished catalysts obtained in accordance with the procedure described immediately above may be mounted in a conventional manner within a suitable canister, which may be made of a suitable metal such as stainless steel or titanium or a titanium alloy. As is conventional in the art, the canister will normally have truncated cone-shaped inlet and outlet sections with the bases of the cones adjacent the opposite end faces of the cylindrical substrate, to facilitate connecting the canistered catalyst in a pipe or duct through which the air or other gas to be treated is flowed. As indicated above, usually the catalysts of the present invention will be provided in a number of segments, typically five to seven or eight segments spaced apart one from the other and suitably mounted within the canister. As is known in the art, at least with respect to ceramic-type substrate catalysts, a ceramic fiber blanket, such as that sold under the trademark CERABLANKET by Thermal Ceramics or under the trademark DURABLANKETS by the Carborundum Company may be employed. Such ceramic blankets are available in several different thicknesses and densities. The ceramic blanket is wrapped about the exterior surface of the catalyst segments in order to both provide thermal insulation and help to maintain the segments firmly mounted in place within the canister. As is also known in the art, instead of a ceramic blanket a resilient wire mesh may be utilized. If needed, suitable retaining rings or the like may also be utilized to securely mechanically retain the catalyst segments in place within the canister.

### Example 2

Samples made in accordance with the present invention were prepared by first preparing samples in accordance with Comparative Example 1 and/or samples available BASF Catalysts LLC, sold under the brand name BASF Catalysts's Deoxo® were utilized and an overcoat coat was prepared and applied to these samples as described below.

After formation of the first layer, an overcoat layer can be applied to the catalytic converter by making a slurry or washcoat of a manganese component, for example, a mixture of a high surface area manganese dioxide available from Chemetals, Inc., Baltimore, Md., manganese nitrate, both in an amount to provide a loading on the substrate of about 0.0112 g/in³ and a high surface area mesoporous gamma alumina, for example GA-200 mixed in the slurry to provide a loading on the substrate of about 0.1 to 2 g/in³, more specifically about 0.1 to 0.5 g/in³, and it specific embodiments about 0.2235 g/in³. Suitable manganese components include, but are not limited to manganese dioxide, non-stoichiometric manganese dioxide, cryptomelane, manjiroite and coronadite, Mn(NO₃)₂ and Mn₂O₃. The pH of the slurry can be adjusted as necessary to the range of 4.0 to 6.0, and the desired particle size of the particles in the slurry are in the range of 90% of the particles being less than 7 to 15 microns. The slurry can be applied as a washcoat on the first layer in an amount of about 0.25 g/in³ to provide an overcoat layer that protects the catalytic component in the first layer from degradation in use.

### Example 3

### Testing of Samples

Experimental methods were developed to poison sample catalysts in a similar mode as observed in aged catalysts used in an aircraft. Performance measurements on a model gas reactor were conducted on both sample sets. From these activities, it was shown that laboratory prepared catalysts closely tracked the field catalysts relative to their poison profiles and performance characteristics. This approach enabled the development of an optimized technology to mitigate the effects of chemical poisoning. A laboratory model gas reactor was employed to measure performance over a range of temperatures and flow rates for field aged samples and laboratory prepared samples. The general test conditions employed to evaluate the many samples were as follows: Air flow=1000 SLPM; Max space velocity=1,000,000; Sample diameter=19.05 mm; Max sample bed length=195.58 mm; Max air temperature=400° F.; Max ozone concentration=2 PPM.

The data collected included ozone performance of sample cores at temperatures of: 148° C., 177° C. and 200° C. at 12 psig at space velocities, (VHSV) of: 280 k/H=0.790 lbs/sec; 388 k/H=1.094 lbs/sec; and 936 k/H=2.640 lbs/sec. As used herein, volume hourly space velocity (VHSV) is defined as follows. In a fixed catalyst bed, residence time for reactants is defined in terms of the volumetric flow and volume of catalyst, both easily measured. Volume Hourly Space Velocity or VHSV is obtained by dividing the volume gas flow by the volume of catalyst at STP. Its reciprocal is the residence time, t. VHSV=1/t.

Pass/Fail criteria for model gas reactor evaluations for catalyst performance was defined as the achievement of 84.5% and greater ozone decomposition performance at a space velocity of 946,000 k/Hr=(2.64 lbs/sec) at 200° C.

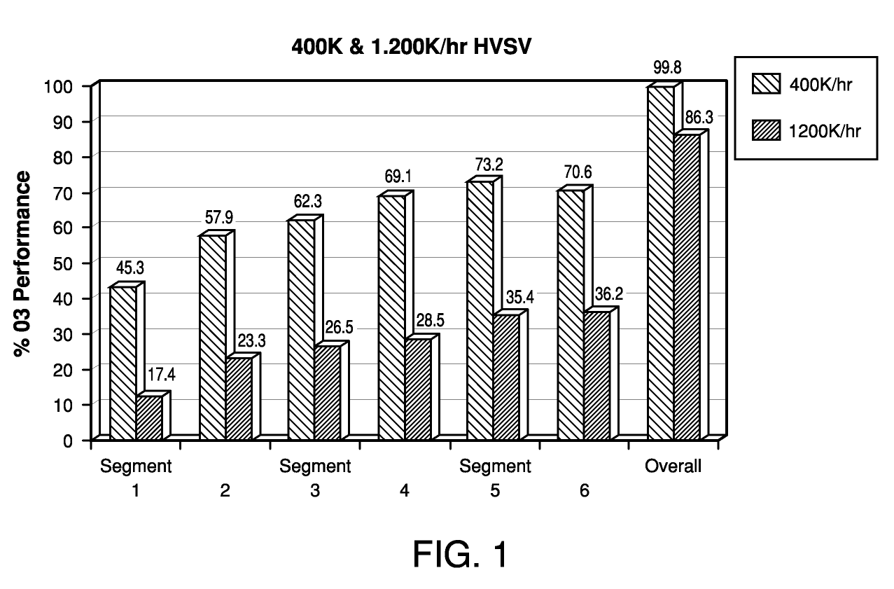

FIG. 1 shows the results of measurements collected from a field aged catalyst prepared generally in accordance with the procedures of Comparative Example 1, and available commercially under the brand name Deoxo® from BASF Catalysts LLC. The converter was designed for an Airbus A320 aircraft that included 6 segments with diameters of 209.14 mm×21.59 mm, with an accumulated 5 thousand flight hours. The data was collected from sample cores removed from the matrix at two space velocity's, intermediate and high, to show intrinsic performance effects. Higher efficiencies at 200° C. were observed in samples measured at low space velocity conditions and explained by longer residence time. Most notable are the data from inlet areas. In particular the first three segments the performance appears to improve steadily and begins to level out in the last three segments shown in FIG. 1.

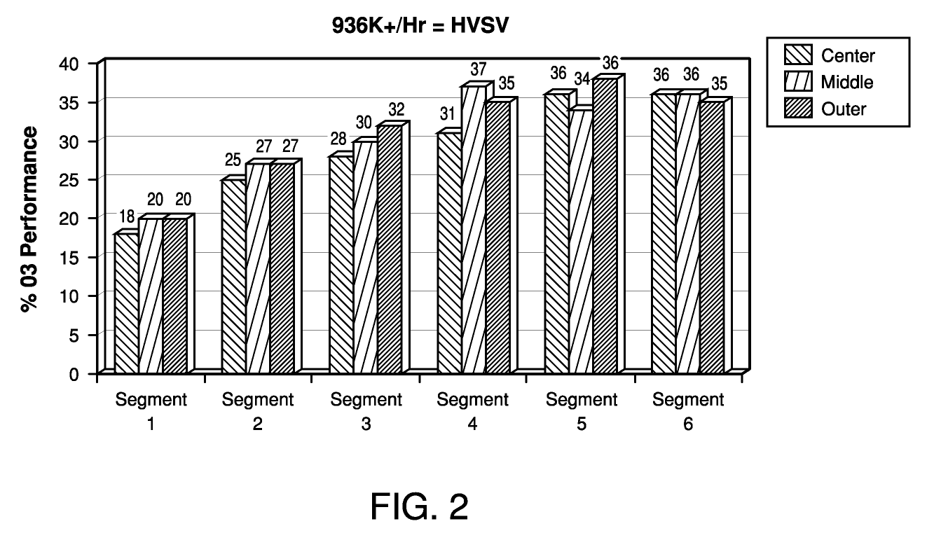

Additional measurements revealed the impact on contaminants from inlet to outlet as well as radial effects. The performance data measured at 200° C. in FIG. 2 clearly shows the matrix center exhibiting the highest catalyst deterioration and less impact on the perimeter areas.

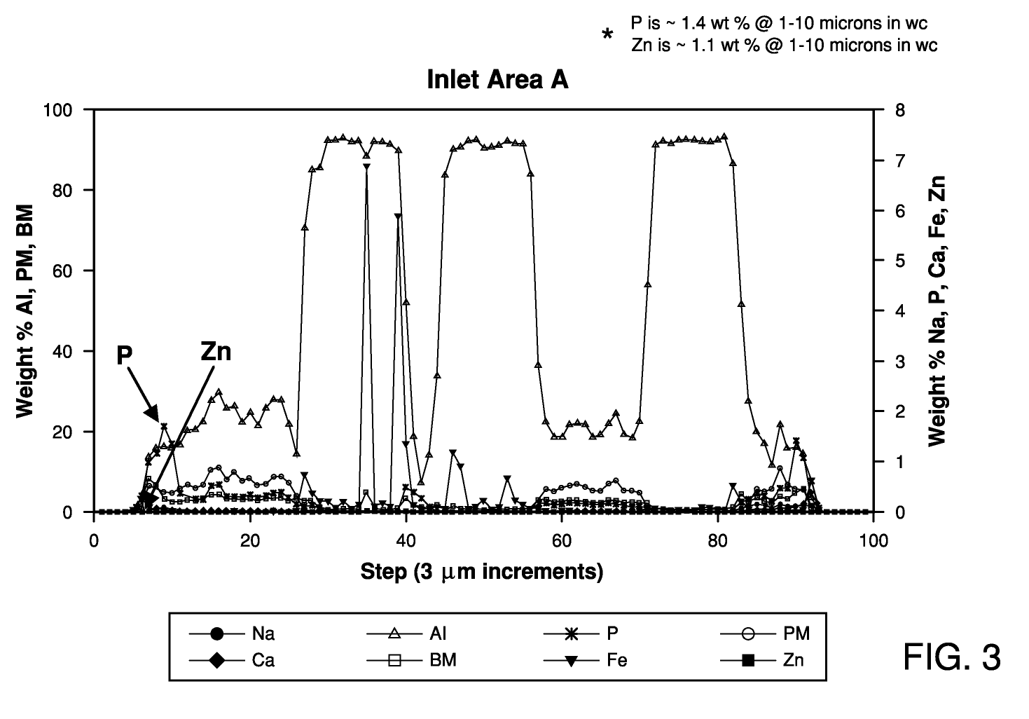

Sample cores from the field aged catalyst were analyzed by Electron Microprobe with a Wide Dispersive X-ray analyzer. The data showed P concentration ˜1.4 wt % on the surface of the catalyst with penetration of ˜1 to 10 microns into the catalyst while Zn was detected to be in relatively low amounts, ˜0.1 wt % and penetration similar to that of P, as depicted in FIG. 3.

In an attempt to duplicate field aged poisoning, several materials were evaluated, but results showed P and Zn species migrated readily through the catalyst. An alternate approach involved the application of an off the shelf engine oil, (Pennzoil 10-30W). In this instance, oil was sprayed on the catalyst surface by an air assisted atomizer. This approach and oil package produced the desired effect and contamination profile similar to the field aged catalyst. Sample cores from this technique were characterized by an Electron Microprobe using a Wide Dispersive X-ray analyzer. The data showed P ˜0.70 wt % on the surface of the catalyst ˜1 to 10 micron wash coat penetration. Zn was detected are approximately a similar concentration and location within the catalyst.

Contamination from oil based compounds has long been known to contribute to similar catalyst failures in a wide range of commercial applications. Zn and P essentially mask active sites or physically block access to these sites.

A laboratory procedure employed applying chemical contaminants to simulate actual use conditions. The procedure utilized a small gas/liquid air assisted atomizer that directly deposited lubricating oil directly to the surfaces of sample cores to a wet gain loading of ˜2.66 grams/in³. The sample core dimensions used in this study were 19 mm in diameter×21.6 mm length. By directly poisoning catalysts in this manner, chemical effects and corrective measured instituted to mitigate these effects were characterized and screened for contamination and performance.

However, there were differences in the poison profiles from the field aged and laboratory catalysts as observed in SEM data. For example, the field aged catalyst in this study had very little Zn on the catalyst with a measurable amount of P. In the laboratory samples, roughly equal amounts of P and Zn were observed. It is proposed that P and Zn, although different in both sample sets, have affects in terms of masking active sites and block access to these sites. It is further proposed the changes effected will have the same beneficial effect on maintaining performance whether P is considerably higher in one catalyst or Zn is present or not at all. In fact, these measures will likely have beneficial impact on other species such as Lead and Sulfur, depending on the oil package an OEM employs in their aircraft.

Performance effects using a model gas reactor from laboratory oil contaminated catalysts clearly show catalyst performance was impacted. It is particularly evident the greatest effects on performance were observed at higher space velocity's and lower temperatures.

Experiments were conducted to compare prior art catalysts with catalysts according to embodiments of the present invention. A first approach encompassed the evaluation of technology that has been successfully developed and demonstrated in mobile source applications, such as automotive and diesel platforms. Additional testing revealed residence time and access to active sites were crucial in maintaining performance, particularly at higher space velocities and lower temperatures. The fresh performance of prior art catalysts was negatively impacted at higher space velocities and low temperatures.

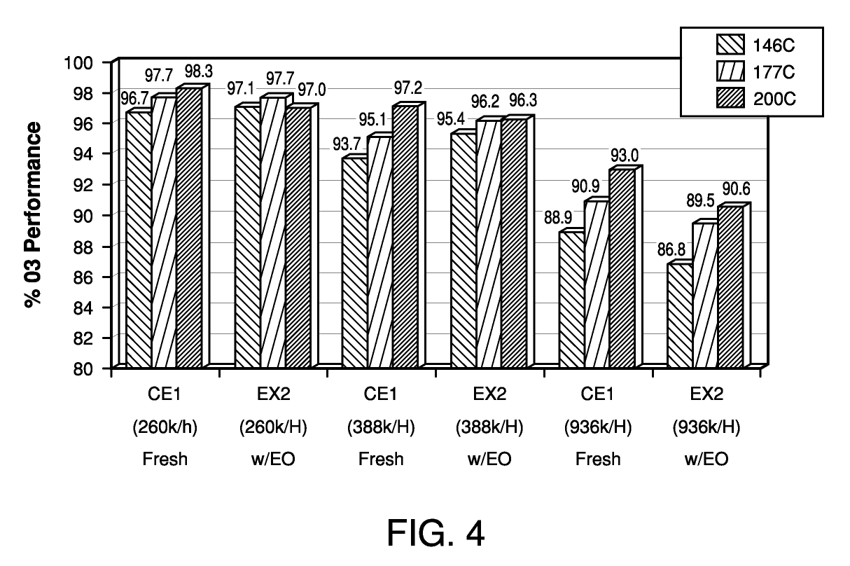

Further experiments were conducted to study the effects of chemical poisoning with the objective of not severely damaging fresh activity at high flow rates and low operating temperatures. Design of experiments was used to screen the following parameters: supports, promoters, processing, formulation, and materials. The design of experiments resulted in a catalyst design that yielded similar fresh performance characteristics to the prior art catalyst, but over a wider range of space velocities and temperatures for samples tested in a model gas reactor, as shown in FIG. 4. The results of FIG. 4 show that overcoated samples in accordance with Example 2 performed well over a wide range of flow rates. The samples labeled “CE1” were prepared in accordance with Comparative Example 1, and the samples labeled “Ex2” were prepared in accordance with Example 2. The samples labeled “w/EO” were contaminated with engine oil as described above. As FIG. 4 shows, samples prepared in accordance with Example 2 performed nearly as well as the comparative examples that were not contaminated with engine oil.

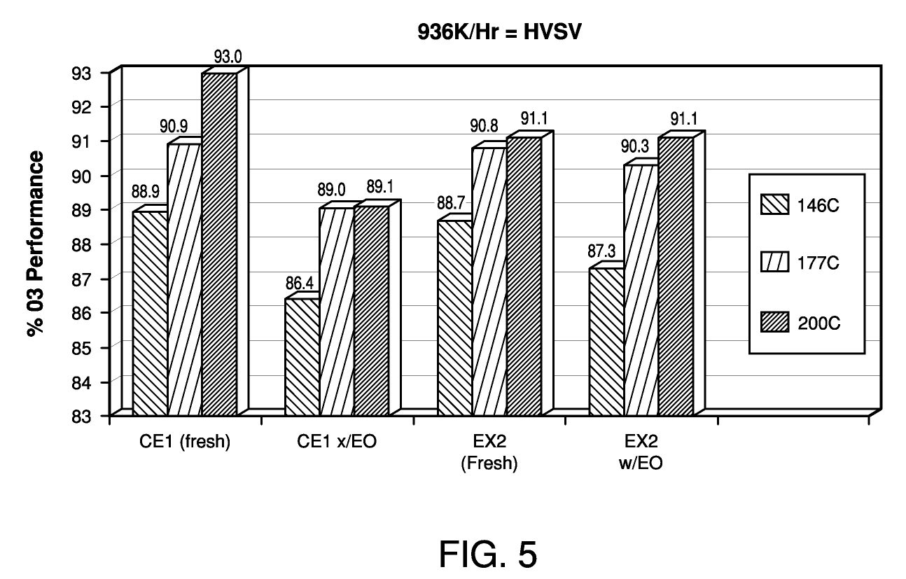

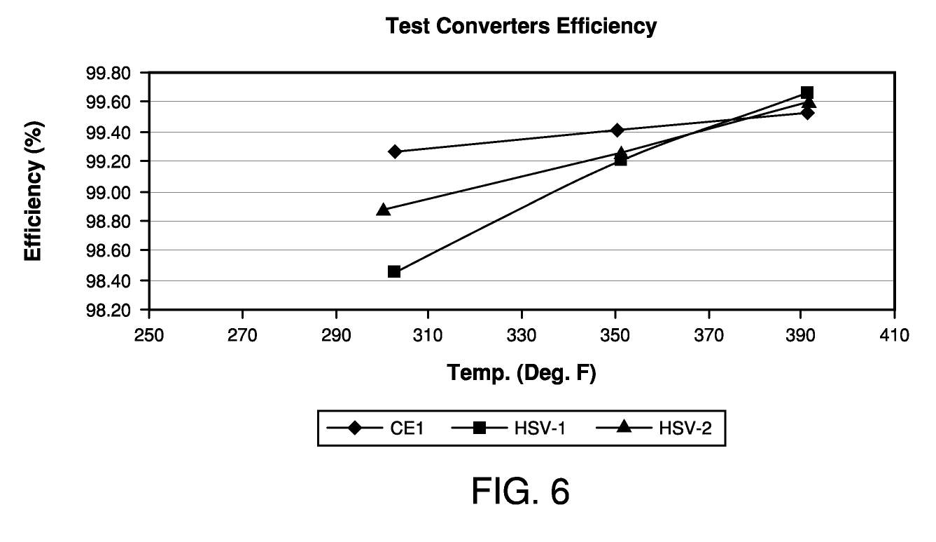

While laboratory tests demonstrate that current catalyst technology can meet performance requirements of 84.5% efficiency at 3 thousand flight hours, catalysts made according to embodiments of the present invention demonstrate a measurable improvement and maintenance of performance following like aging and beyond while still maintaining reasonable performance, as depicted in FIG. 5.

### Full Size Evaluation

To confirm model gas reactor results, three full size converters were prepared, assembled and evaluated for performance and back pressure. Full size converters consist of six separate segments arranged axially along the length of canister. For these tests, the matrix design for a commercial aircraft and end cones were employed. All three converters and their respective matrix technologies were performance tested under low flow conditions in a laboratory reactor that simulated actual use conditions.

The designs are identified as follows:
Comp.1=the standard catalyst without modification
HSV-1 with all six catalysts prepared in accordance with Example 2.

HSV-2 only the first three segments were prepared in accordance with Example 2, and the last three segments were prepared in accordance with Comparative Example 1.

Evaluation conditions in a laboratory and results are depicted in Table 1 and FIG. 6, as follows

TABLE 1

| | | Inlet | | | | | | |
|---|---|---|---|---|---|---|---|---|
| | Air | Temp | | Temp. | | OZONE | | |
| | Blower | (deg. | Flow | (deg. | Back P | Conversion | | |
| Sample | (psi) | F.) | (lb/sec) | F.) | (“H₂O) | Inlet | Outlet | Efficiency % |
| COMP. 1 | 1.579 | 112.9 | 1.090 | 302.7 | 17.3 | 1.500 | 0.011 | 99.27 |
| | 1.672 | 113.6 | 1.080 | 350.5 | 18.4 | 1.514 | 0.009 | 99.41 |
| | 1.774 | 115.0 | 1.090 | 391.2 | 19.8 | 1.495 | 0.007 | 99.53 |
| HSV-1 | 1.631 | 110.6 | 1.100 | 302.8 | 18.0 | 1.485 | 0.023 | 98.45 |
| | 1.697 | 112.8 | 1.090 | 351.3 | 19.1 | 1.507 | 0.012 | 99.20 |
| | 1.766 | 113.2 | 1.090 | 391.7 | 20.3 | 1.489 | 0.005 | 99.66 |
| HSV-2 | 1.587 | 112.8 | 1.080 | 300.2 | 16.8 | 1.501 | 0.017 | 98.87 |
| | 1.679 | 113.9 | 1.090 | 351.3 | 18.6 | 1.482 | 0.011 | 99.26 |
| | 1.778 | 113.5 | 1.090 | 391.7 | 19.8 | 1.517 | 0.006 | 99.60 |

Full size performance results in Table 1 and FIG. 6 show fresh conversion efficiencies are almost identical in all three designs except for small differences at the lower temperature. These differences, although small, can be attributed to the masking effect of precious metal species throughout the matrix. Thus, samples prepared in accordance with the present invention exhibit similar conversion efficiency to currently commercially available converters and can perform for extended periods of time.

The catalyst samples prepared in accordance with embodiments of the present invention meet requirements for life, (at least about 84.5% ozone conversion efficiency for at least about 3,000 flight hours). Results have been confirmed using an in-flight aged commercial ozone converter retrieved from a commercial aircraft that was aged for 5,000 flight hours. The standard catalyst without modification was used as an internal reference as well as samples that have been poisoned in a like fashion to the field-aged converter. Performance evaluations occurred on well calibrated and high controlled model gas reactor. The catalysts prepared according to embodiments of the present invention demonstrate performance benefits beyond the current technology for the mitigation of chemical contaminants typically found on aircraft ozone abatement systems.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. An ozone-destroying catalytic converter comprising:
a substrate;
at least a first washcoat layer comprising a refractory metal oxide support having a catalytic metal component dispersed on a refractory metal oxide support; and
an overcoat washcoat layer on the first layer comprising a manganese component.

2. The catalytic converter of claim 1, wherein the manganese component comprises one or more of manganese dioxide, non-stoichiometric manganese dioxide, cryptomelane, manjiroite and coronadite, Mn(NO₃)₂ and Mn₂O₃.

3. The catalytic converter of claim 2, wherein the manganese comprises manganese dioxide.

4. The catalytic converter of claim 3, wherein the catalytic converter is adapted for use in an aircraft exhibits ozone destruction efficiency equal to or greater than about 84.5% and greater after about 3,000 flight hours.

5. The catalytic converter of claim 4, wherein the manganese dioxide has a surface area greater than about 100 m²/g.

6. The catalytic converter of claim 5, wherein the manganese dioxide has a surface in the range of about 150 m²/g and 350 m²/g.

7. The catalytic converter of claim 3, comprising an undercoat washcoat layer on the substrate comprising a refractory metal oxide and a sol selected from one or more of silica, alumina, zirconia and titania sols, and the first washcoat layer is disposed on the undercoat layer.

8. The catalytic converter of claim 7, wherein the undercoat washcoat layer comprises from about 5 to 50 percent by weight of the fine particulate refractory metal oxide and from about 50 to 95 percent by weight of the sol.

9. The catalytic converter of claim 8, wherein the sol comprises a silica sol.

10. The catalytic converter of claim 9, wherein the refractory oxide support in the first layer comprises mesoporous alumina.

11. The catalytic converter of claim 8, wherein the substrate comprises a body having a plurality of gas flow passages extending therethrough the passages being defined by walls on which the catalytic material is coated, and the loading of the underlayer does not exceed about 0.3 g/in³.

12. The composition of claim 11, wherein the catalytic metal component comprises a palladium component and a manganese component.

13. The catalytic converter of claim 11, wherein the substrate comprises a metal substrate made of a metal selected from the class consisting of aluminum, aluminum alloys, titanium and titanium alloys.

14. The catalytic converter of claim 11, wherein the catalytic metal component comprises a palladium component dispersed on the first refractory metal oxide support by impregnating the refractory metal oxide support with a palladium salt selected from the group consisting of palladium tetraamine salts and palladium nitrate.

15. A method of preparing a catalyst composition comprising: (a) applying to a substrate an undercoat layer comprising a mixture of a fine particulate undercoat refractory metal oxide and a sol selected from one or more of silica, alumina, zirconia and titania sols by contacting the substrate with first coat slurry of the first coat refractory metal oxide and the sol in a liquid medium and thereafter heating the applied first to fix it to the substrate; (b) applying to the undercoat obtained in step (a) a first layer comprising an first layer refractory metal oxide support, by contacting the substrate containing the undercoat with a slurry of a refractory metal oxide support particles in a liquid medium and thereafter heating the applied first layer slurry to fix it to the undercoat; (c) applying at least one catalytic metal component to the first layer refractory metal oxide support; and (d) applying to the first layer an overcoat layer comprising a manganese component by contacting the substrate containing the undercoat layer and the first layer with an overcoat slurry comprising one or more of manganese dioxide, non-stoichiometric manganese dioxide, cryptomelane, manjiroite and coronadite, Mn(NO₃)₂ and Mn₂O₃.

16. The method of claim 15 wherein step (c) is carried out by impregnating the first layer refractory metal oxide with a solution of one or more salts comprising a precursor of one or more catalytic metal components.

17. The method of claim 16 wherein the catalytic metal components comprise a palladium component and, optionally, a manganese component.

18. The method of claim 17, wherein the overcoat slurry containing manganese oxide and Mn(NO₃)₂.

19. The method of claim 18, wherein the manganese dioxide has a surface area greater than about 100 m²/g.
